(19) United States
(12) Patent Application Publication
(10) Pub. No.: US 2008/0092237 A1
(43) Pub. Date: Apr. 17, 2008

(54) SYSTEM AND METHOD FOR NETWORK VULNERABILITY ANALYSIS USING MULTIPLE HETEROGENEOUS VULNERABILITY SCANNERS

(76) Inventors: Jun YOON, Yongin-si (KR); Kyoung Hee Ko, Incheon (KR); Tae In Jung, Seoul (KR); Won Tae Sim, Sungnam-si (KR); Woo Han Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/553,196

(22) Filed: Oct. 26, 2006

(30) Foreign Application Priority Data
Oct. 13, 2006 (KR) 10-2006-0099642

(51) Int. Cl. G06F 11/00; G06F 12/14; G06F 12/16; G06F 15/18; G08B 23/00

(52) U.S. Cl. 726/25

(57) ABSTRACT

An integrative analysis system and method of network vulnerability utilizing multiple heterogeneous vulnerability scanners to enhance the accuracy of the network vulnerability analysis are provided. The method comprises a scanning policy setting-up step of setting-up a common scanning policy able to be adapted to the multiple heterogeneous vulnerability scanners and specifying the policy for the respective vulnerability scanners, a vulnerability scanning and result collecting step of performing for the multiple heterogeneous vulnerability scanners to scan, to collect a result thereof, and to store the same in a database and a scanning result integrative analysis step of performing a relevance analysis and an integrative analysis on the scanning results collected, thereby obtaining a complementary vulnerability scanning utilizing multiple heterogeneous vulnerability scanners, enhancing the accuracy and the comprehension of the scanning results, and obtaining a comprehensive vulnerability analysis on a network.

### CROSS-REFERENCE TO RELATED APPLICATIONS

This application claims all benefits of Korean Patent Application No. 10-2006-0099642 filed on Oct. 13, 2006 in the Korean Intellectual Property Office, the disclosures of which are incorporated herein by reference.

### BACKGROUND OF THE INVENTION

1. Field of the Invention

The present invention relates to a system and method for network vulnerability analysis using multiple heterogeneous vulnerability scanners, and more particularly to a system and method as integrated technology of various heterogeneous vulnerability scanners for enhancing the degree of accuracy for network vulnerability analysis, which is able to provides the flexibility to the selection of vulnerability scanners, and able to perform the complementary vulnerability scanning as well as to enhance the accuracy and the comprehension for the vulnerability scanning result, thereby obtaining the comprehensive vulnerability analysis for the network.

2. Description of the Prior Art

As the reliance on telecommunications grows in the national major infrastructures as well as in the personal economical activities such as online shopping, Internet banking, and so forth, it is needed that a telecommunication network has to be protected from hacking and worm/virus and managed safely.

The best method to protect the telecommunication network from hacking and worm/virus is to grasp a problem and map out the provisions against the problem to prevent damage previously.

Automated vulnerability scanners are utilized in analyzing the network vulnerability. However, there are various kinds of vulnerability scanners whose scanning targets are different, and even for the same kind of vulnerability scanners, the scanning items and the scanning results may be different.

Although it may be experientially evaluated that the particular vulnerability scanner is somewhat excellent, it cannot determine that the results from the scanner are absolutely accurate, or all vulnerabilities existing in the scanning target are detected.

Accordingly, there are many cases in which upon the network vulnerability analysis and assessment, various heterogeneous scanners, instead of a single scanner, are simultaneously utilized with the purpose of complementing each other.

However, in the case of simultaneously utilizing various heterogeneous vulnerability scanners, the formats and the technical levels of the results are different by each vulnerability scanner and the relevance between information is hardly detected, so that it is impossible to automate the integrative analysis, or otherwise the manual analysis thereby becomes time-consumable. Although there is an approved ID system in various security products such as CVE ID, Bugtraq ID, and so forth to identify the same vulnerability and many developing companies for heterogeneous scanner are utilizing such approved vulnerability ID, in fact, there is also a vulnerability scanner which does not use such approved vulnerability ID, and even in the scanning result from the scanner using the approved vulnerability ID, such ID information is not essentially allocated to all vulnerabilities. Since it takes much time until the issuance of approved ID after detecting the vulnerability for the first time, there may exist the vulnerabilities to which approved vulnerability IDs is not yet issued, or which do not have the approved vulnerability IDs for the diverse reasons such as, for example, various standards by a vulnerability finder and an examiner of issuance of approved vulnerability ID. Accordingly, it is not enough to integrate the vulnerability scanning results with only approved vulnerability ID.

FIG. 1 is a block diagram for an example of an integrative analysis method utilizing the multiple heterogeneous vulnerability scanners, and FIG. 2 is a flow chart of an example of the integrative analysis method utilizing the multiple heterogeneous vulnerability scanners.

Referring to FIGS. 1 and 2, the construction for integrative analysis method utilizing the general multiple heterogeneous vulnerability scanners includes multiple heterogeneous vulnerability scanners 11 and 12, and 21 and 22 installed in the networks 1 and 2 (10 and 20) to perform the scanning of the network vulnerability, managers 13 and 14, and 23 and 24 transmitting the scanning policy set-up and a scanning instruction to the respective multiple heterogeneous vulnerability scanners and storing the scanning results thereof, and an integrative manager 30 integrating and analyzing the scanning results that are collected from the respective managers 13 and 14, and 23 and 24 to calculate the final result thereof. That is, in case of, at present, performing the network vulnerability analysis utilizing various heterogeneous vulnerability scanners, a generally used method is a manual analysis method by a person.

Describing in detail a flow of an example of the integrative analysis method with reference to FIG. 2, when the manager 13 of the network 110 sets up a scanning policy and commands the scanning to corresponding vulnerability scanner 11 (S11), the vulnerability scanner 11 performs the scanning (S12).

The manager 13 stores the scanning result manually (S13) and checks whether of other vulnerability scanners (S14).

If other vulnerability scanners exist, it is done to repeat the steps S11 to S14. For example, other vulnerability scanners 12, 21 and 22 also repeat the steps S11 to S14.

The integrative manager 30 collects manually the scanning result on the vulnerability scanners (S15), manually integrates and analyzes the scanning result (S16), and manually arranges the analysis result (S17).

Like above, an example of the integrative analysis method utilizing the multiple heterogeneous vulnerability scanners is a method in which a person himself/herself analyzes relevance between the results from different heterogeneous vulnerability scanners, and arranges the result after determining the accuracy of the vulnerabilities. The manual integrative analysis is time-consumable and hardly manages the vulnerability analysis results systematically. In case that, in particular, a scanning target network is large and complex, it may be impossible to utilize the multiple heterogeneous vulnerability scanners using the manual integrative analysis method.

### SUMMARY OF THE INVENTION

Accordingly, the present invention has been made to solve the above-mentioned problems occurring in the prior art thus to utilize various heterogeneous scanners while integrating in order for enhancing the accuracy of analysis of network vulnerability. In specific, an object of the present invention is to automate an integrated analysis method for network vulnerability, to enhance the accuracy of vulnerability analysis result, and to allow the flexible selection and the utilization of diverse heterogeneous vulnerability scanners, through an integrative analysis method of the relevance between vulnerability information based on the scanning results from various heterogeneous scanners, the central control for the heterogeneous scanners, and a consistent set-up method of vulnerability scanning policy.

In order to accomplish the above objects, there is provided an integrative analysis system for network vulnerability, utilizing multiple heterogeneous vulnerability scanners, which system comprises: multiple heterogeneous vulnerability scanners for scanning the vulnerability of a network; a plurality of agents installed on the same system as those of respective vulnerability scanners to perform the execution and control for the corresponding vulnerability scanner, the reception of the scanning policy, and the transfer of the scanning results; a vulnerability managing and integrating module collecting the scanning results of the respective vulnerability scanners while communicating with the respective agents, performing a relevance analysis of the scanning results, and storing a analysis result in a vulnerability database; and a vulnerability scanning control and analysis center performing the control and the execution of the multiple heterogeneous vulnerability scanners, performing an integrative analysis based on the scanning results of the multiple heterogeneous vulnerability scanners and the relevance analysis result to show to the manager through a graphical user interface (GIU), providing the manager with a query for the integrative analysis result and a feedback function, and managing scanning policy history to maintain the consistency of the vulnerability scanning policy.

Herein, the respective agents includes: a communication agent module communicating with the vulnerability scanning control and analysis center and the vulnerability managing and integrating module; a vulnerability scanner control module performing a command on vulnerability control transmitted from the vulnerability scanning control and analysis center, transferring a result of command execution, and performing a command including any of vulnerability scanning execution, pause, re-start, stop, state reference of the vulnerability scanner; a scanning policy specifying module adapting a common scanning policy transmitted from the vulnerability scanning control and analysis center to the corresponding vulnerability scanner; and a scanning result generalization module transforming the scanning results into a generalized format able to be received by the vulnerability managing and integrating module and transferring the same.

Herein, the vulnerability managing and integrating module includes: a vulnerability manager communicating with the respective agents and the vulnerability scanning control and analysis center and transferring an external request to a module in charge; a scanning policy management module storing the scanning policy transferred from the vulnerability scanning control and analysis center and retrieving the scanning policy adapted in the past according to a request; a scanning result integration module connected with the respective agents to collect the scanning result and store the same in the vulnerability database; a vulnerability database manager being in charge of input/output with the vulnerability database; and a relevance analysis module analyzing the scanning results collected from the multiple heterogeneous vulnerability scanners in terms of their relevance to identify the same vulnerabilities and to eliminate the duplication.

In another aspect of the present invention, there is provided an integrative analysis method of network vulnerability utilizing multiple heterogeneous vulnerability scanners, which method comprises: a scanning policy setting-up step of setting-up a common scanning policy able to be adapted to the multiple heterogeneous vulnerability scanners and specifying the policy for the respective vulnerability scanners; a vulnerability scanning and result collecting step of performing for the multiple heterogeneous vulnerability scanners to scan, to collect a result thereof, and to store the same in a database; and a scanning result integrative analysis step of performing a relevance analysis and an integrative analysis on the scanning results collected.

Herein, the scanning policy setting-up step includes: generating the common scanning policy; adapting the common scanning policy to the multiple heterogeneous vulnerability scanners and controlling the same; and specifying the common scanning policy in conformity with the multiple heterogeneous vulnerability scanners.

Herein, the vulnerability-scanning and result-collecting step includes: performing the vulnerability scanning at the same time; generalizing the scanning result after scanning; and automatically collecting the scanning result from the multiple heterogeneous vulnerability scanners and storing the same.

Herein, the scanning result integrative-analysis step includes: analyzing relevance between vulnerabilities found-out by the heterogeneous scanners; analyzing relevance between vulnerabilities detected by the heterogeneous vulnerability scanners; performing an integrative analysis on the scanning result and storing a result thereof; and performing a manager's feedback on the analysis result.

Herein, if there is a correction in the scanning result after the manager's feedback, the step returns to the integrative-analysis and result-storing step so that the scanning result is corrected and stored.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram for an example of an integrative analysis method utilizing the multiple heterogeneous vulnerability scanners;

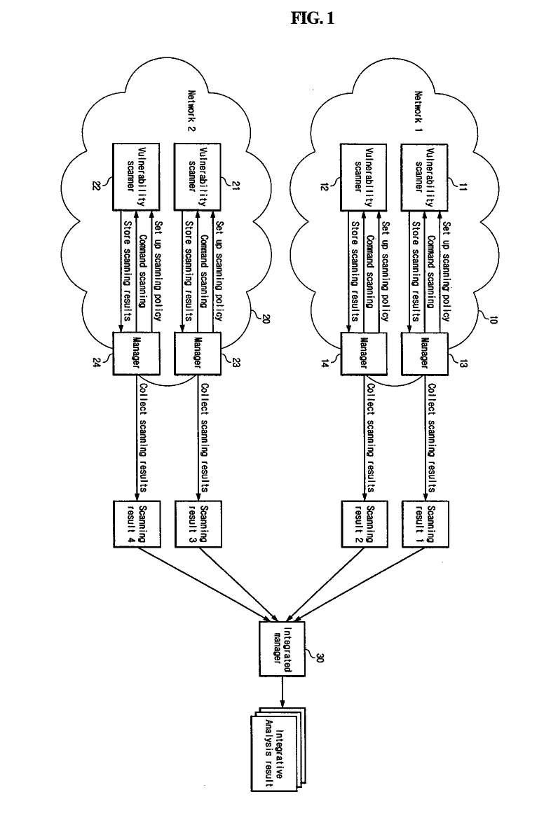

FIG. 2 is a flow chart of an example of the integrative analysis method utilizing the multiple heterogeneous vulnerability scanners;

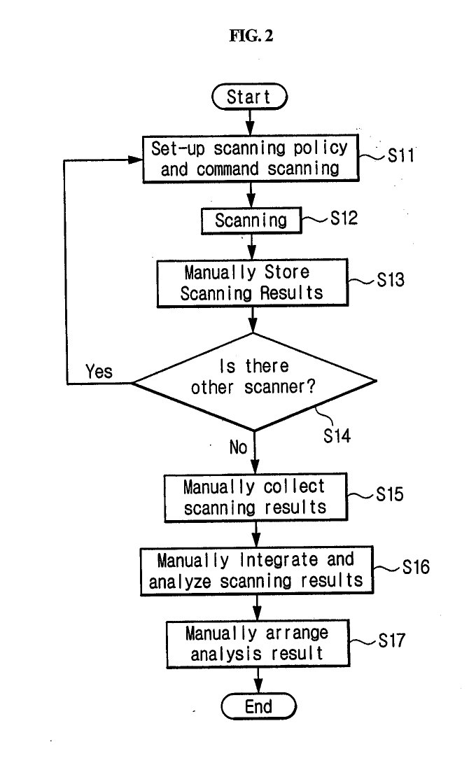

FIG. 3 is a block diagram for an integrative analysis system of network vulnerability, utilizing multiple heterogeneous vulnerability scanners according to an embodiment of the present invention;

FIG. 4 is a flow chart of an integrative analysis method of network vulnerability, utilizing multiple heterogeneous vulnerability scanners according to an embodiment of the present invention; and

FIG. 5 is a constructional diagram in which a common scanning policy is specified in conformity with the options of the respective vulnerability scanners according to an embodiment of the present invention.

### DETAILED DESCRIPTION OF THE PREFERRED EMBODIMENTS

Hereinafter, preferred embodiments of the present invention will be described in detail with reference to the accompanying drawings.

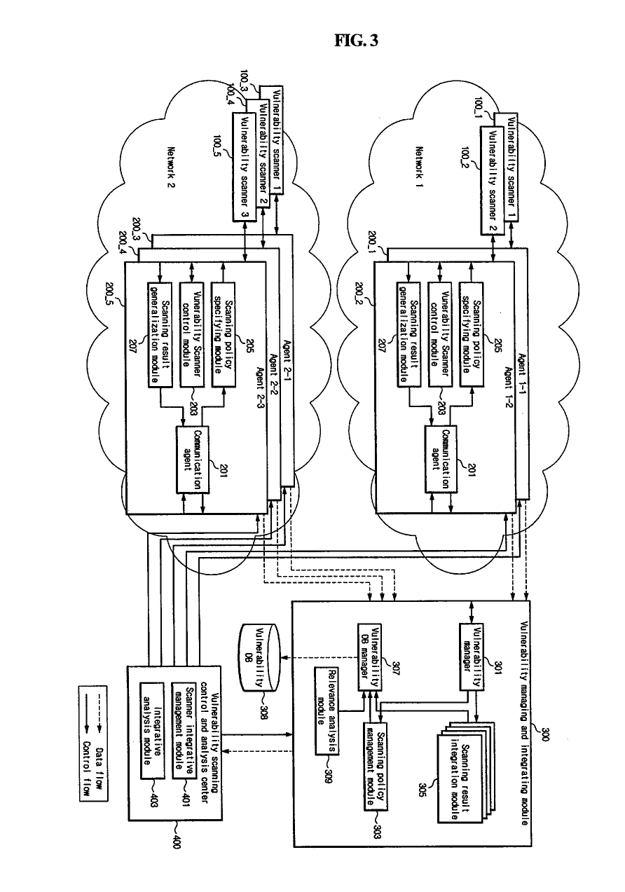

FIG. 3 is a block diagram for an integrative analysis system of network vulnerability, utilizing multiple heterogeneous vulnerability scanners according to an embodiment of the present invention.

Referring to FIG. 3, the integrative analysis system of network vulnerability utilizing multiple heterogeneous vulnerability scanners includes multiple heterogeneous vulnerability scanners 100_1, 100_2, 100_3, 100_4, and 100_5, a plurality of agents 200_1, 200_2, 200_3, 200_4, and 200_5, a vulnerability managing and integrating module 300, and a vulnerability scanning control and analysis center 400.

To enhance the accuracy and the comprehension of the scanning result on network vulnerability, it is installed reliable or available multiple vulnerability scanners 100_1, 100_2, 100_3, 100_4 and 100_5. The installation is carried out such that the respective vulnerability scanners are able to scan as efficient as possible according to installation instructions distributed from the scanner developer. For effective scanning, if necessary, the same vulnerability scanners may be installed at every network, or otherwise a single vulnerability scanner may scan the whole network.

The plurality of agents 200_1, 200_2, 200_3, 200_4, 200_5 are installed on the same system as those of the respective vulnerability scanners 100_1, 100_2, 100_3, 100_4, and 100_5 to serve as a function of the execution and control of the corresponding vulnerability scanner, the scanning policy reception, the scanning result transfer, and so forth.

Each agent 200_1, 200_2, 200_3, 200_4, or 200_5 includes a communication agent module 201, a vulnerability scanner control module 203, a scanning policy specifying module 205, and a scanning result generalization module 207. The communication agent module 201 communicates with the vulnerability scanning control and analysis center 400 and the vulnerability managing and integrating module 300. The vulnerability scanner control module 203 performs a command on vulnerability control transmitted from the vulnerability scanning control and analysis center 400, and transfers a result of command execution. It performs a command including any of vulnerability scanning execution, pause, re-start, stop, state reference of the vulnerability scanner. The scanning policy specifying module 205 serves to specify a common scanning policy transmitted from the vulnerability scanning control and analysis center 400 in conformity with the corresponding vulnerability scanner. The scanning result generalization module 207 serves to transform the scanning results into a generalized format able to be received by the vulnerability managing and integrating module 300 and to transfer the same.

The vulnerability managing and integrating module 300 collects the scanning results of the respective vulnerability scanners 100_1, 100_2, 100_3, 100_4, and 100_5 thru the respective agents 200_1, 200_2, 200_3, 200_4, and 200_5, performs a relevance analysis of the scanning results, and stores a analysis result in a vulnerability database.

The vulnerability managing and integrating module 300 includes a vulnerability manager 301, a scanning policy management module 303, a scanning result integration module 305, a vulnerability database (DB) manager 307, and a relevance analysis module 309. The vulnerability manager 301 serves to communicate with the respective agents 200_1, 200_2, 200_3, 200_4, and 200_5 and the vulnerability scanning control and analysis center 400 and to transfer an external request to a module in charge. The scanning policy management module 303 serves to store the scanning policy transferred from the vulnerability scanning control and analysis center 400 and to retrieve the scanning policy adapted in the past according to a request. The scanning result integration module 305 is connected with the respective agents 200_1, 200_2, 200_3, 200_4, and 200_5 to collect the scanning result and to store the same in the vulnerability database. The vulnerability DB manager 307 is in charge of input/output with the vulnerability database 308. The relevance analysis module 309 serves to analyze the scanning results collected from all the multiple vulnerability scanners 100_1, 100_2, 100_3, 100_4, and 100_5 in terms of their relevance to identify the same vulnerabilities and to eliminate the duplication.

The vulnerability scanning control and analysis center 400 includes a vulnerability scanner integrative-management module 401 performing the control and the execution of the multiple heterogeneous scanners 100_1, 100_2, 100_3, 100_4, and 100_5, and an integrative analysis module 403 performing an integrative analysis based on the scanning results of the heterogeneous scanners 100_1, 100_2, 100_3, 100_4, and 100_5 and the relevance analysis result to thus show to the manager through a graphical user interface (GUI), providing the manager with a query for the integrative analysis result and a feedback function. It further serves to manage scanning policy history to maintain the consistency of the vulnerability scanning policy.

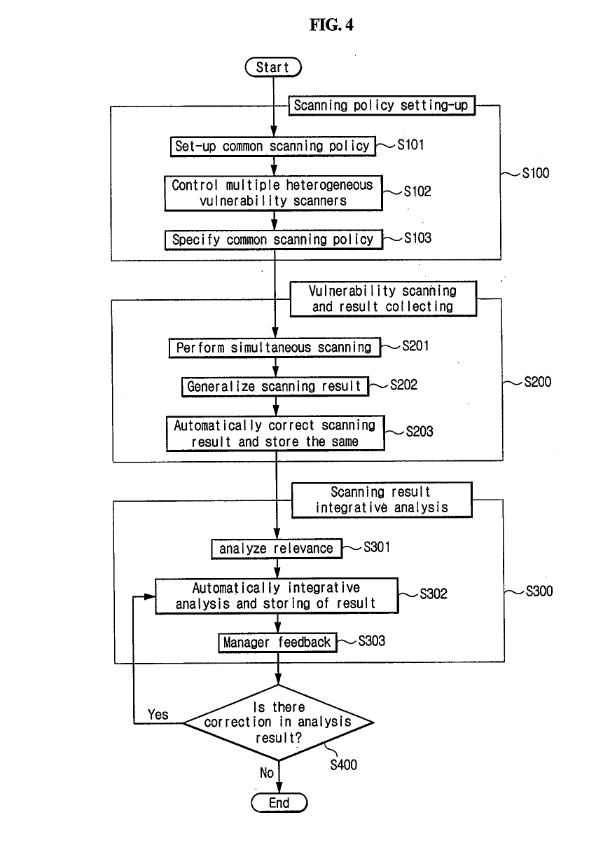

FIG. 4 is a flow chart of an integrative analysis method of network vulnerability, utilizing multiple heterogeneous scanners according to an embodiment of the present invention.

Referring to FIG. 4, the integrative analysis method of network vulnerability comprises a scanning policy setting-up step S100, a vulnerability-scanning and result-collecting step S200, and a scanning result integrative-analysis step S300.

The scanning policy setting-up step S100 is a step of setting-up a common scanning policy able to be adapted to the multiple heterogeneous vulnerability scanners and specifying the policy for the respective vulnerability scanners. Specifically, the scanning policy setting-up step S100 includes setting-up the common scanning policy S101, adapting the scanning policy to the multiple heterogeneous vulnerability scanners and controlling the same S102, and specifying the common scanning policy in conformity with the multiple vulnerability scanners S103. Accordingly, in the scanning policy setting-up step S100, the manager is able to set-up the scanning policy adaptable to all of vulnerability scanners and to control all of vulnerability scanners at the same time. To maintain consistent scanning policy, all the scanning policies adapted should be stored in a database and retrieved to.

The vulnerability scanning and result collecting step S200 is a step of performing for the multiple vulnerability scanners to scan, to collect a result thereof, and to store the same in a database. Specifically, the vulnerability scanning and result collecting step S200 includes performing the vulnerability scanning at the same time S201, generalizing the scanning result after scanning S202, and automatically collecting the scanning result from the multiple vulnerability scanners and storing the same S203. Accordingly, in the vulnerability scanning and result collecting step S200, the vulnerability scanning is performed according to the manager's scanning policy and to generalize the scanning results into a common format. The generalized scanning results are collected centrally and stored in the vulnerability database.

The scanning result integrative analysis step S300 is a step of performing a relevance analysis and an integrative analysis on the scanning results collected. Specifically, the scanning result integrative analysis step S300 includes analyzing relevance between vulnerabilities detected by the heterogeneous vulnerability scanners S301, performing automatically an integrative analysis on the scanning result and storing a result thereof S302, and performing a manager's feedback on the analysis result S303. Herein, if there is a correction in the scanning result S400, the step returns to S302 so that the scanning result is corrected and re-stored. Accordingly, from the above step, it is performed to eliminate the duplication through the analysis on relevance between vulnerability information collected from the respective vulnerability scanners, to generate an identifier capable of identify important vulnerability, to carry out an integrative analysis, and to store the analysis result in the database. The manager is able to refer to the integrative analysis result and to make the integrative analysis result more accurately through a feedback.

Now description will be made to the major technologies adaptable to the respective steps in FIG. 4.

A. Scanning Policy Setting-Up and Managing Technology (S101 in FIG. 4)

The scanning policy expression range and its detailed level are different for each vulnerability scanner. The scanning policy existing in the specified vulnerability scanner may not exist in another vulnerability scanner, and the scanning policy expressed as a single one in the specified scanner may be expressed at another vulnerability scanner as more detailed diverse scanning policies.

For integrative management of the multiple heterogeneous vulnerability scanners, it is needed a scanning policy commonly adaptable to all the vulnerability scanners. The embodiment of the invention defines a generalized vulnerability scanning policy adaptable to the diverse vulnerability scanners as follows:
Target IP Range: IP addresses of target systems and network equipments for vulnerability scanning.
Safe Check: an option provided not to make the system unstable or down due to the vulnerability scanning, and not to affect the network performance due to heavy traffic, which option is provided in most of vulnerability scanners. If a vulnerability scanner does not have such option, it is performed to classify dangerous options, that may have an influence on an operation of a target scanning system and a network, from scanning options and plug-ins, and to newly define a safety scanning option except them.
Scanning Schedule: it is divided and designated into an immediate scanning, a periodic scanning, and a specified date scanning. Through this option, the security manager can carry out a scanning at any time, designate periodic scanning date, or perform the scanning at a particular date.
Plug-In Update Schedule: most of vulnerability scanners should be updated periodically in its database storing the vulnerability scanning information and the plug-in information. An update scheduling is provided as a scanning function in order to maintain latest scanning information. The plug-in update option comprises immediate update, designated date update, and auto update.
Web Server IP and Port: it receives an IP or a domain name of a target web server to be scanned by a web vulnerability scanner and a web service port number. Many web vulnerability scanners should be given the domain name and the port number as well as IP of the target server so that these options should be included as a scanning policy.
Only Web Server Scanning: it is a selective scanning method according to characteristics of the scanning targets, which method scans only a server in which a web service is running among the scanning targets.
Only Specified Port Open Host Scanning: it is a selective scanning method according to characteristics of the scanning targets, which method scans only a host in which a specified port is opened among the scanning targets.
Only Specified OS Scanning: it is a selective scanning method according to characteristics of the scanning targets, which method scans only a host in which a specified OS is running among the scanning targets.
Only Network Equipment Scanning: it is a selective scanning method according to characteristics of the scanning targets, which method scans only network equipment among the scanning targets.
Scanning Time: it is designated a time taken in scanning by vulnerability scanners. The scanning time may be different for each vulnerability scanner. If necessary, the scanning time may be designated so as to complete the scanning within a specified time. It may be performed to scan only major vulnerability items or to regulate a response time limit for a restricted vulnerability scanning time.
Selection of the Kind of Vulnerability Scanner and Scanning Position: when multiple heterogeneous vulnerability scanners are installed and utilized, if necessary, the specified kind of vulnerability scanner and the specified scanning position may be selected.

In the meantime, for consistent maintenance of the vulnerability scanning policy, it is needed history management on the vulnerability scanning policies adapted in the past. A history management function includes following sub-functions.
Scanning Policy Storing Function: when a new scanning policy is selected and adapted to the respective vulnerability scanners, the selected scanning policy contents are stored in a database.
Past Vulnerability Scanning Policy Retrieving function: the scanning policies adapted in the past can be retrieved from the database.
The scanning policy management function is realized at the vulnerability scanning control and analysis center.

B. Technology Controlling Multiple Heterogeneous Vulnerability Scanners (S102 in FIG. 4)

The security manager can control the multiple heterogeneous vulnerability scanners in central method. Through the following control commands, He/She can control all of vulnerability scanners at the same time, or otherwise selectively control a specified vulnerability scanner.

The following control commands can be commonly adapted to the multiple heterogeneous vulnerability scanners. Some functions can be used as it is provided in the vulnerability scanners, and some functions can be emulated in the agent of the vulnerability scanners.
Scanning Start: the vulnerability scanner starts to scan.
Scanning Termination: the vulnerability scanner terminates the scanning.
Scanning Pause: the vulnerability scanner pauses the scanning.
Scanning Re-Start: the vulnerability scanner re-starts the paused scanning.
Scanning State Retrieving: the scanning state of the vulnerability scanner can be retrieved. The scanning state includes a vulnerability scanner error, a scanning on, a scanning off, a new scanning, and so forth.
Scanning Policy Transfer: the vulnerability scanning policy is transferred to the vulnerability scanner.

C. Technology Specifying Scanning Policy in Conformity with Vulnerability Scanner (S103 in FIG. 4)

Since a range and its detailed level of the scanning option are different for each scanner, it is needed to specify a common scanning policy in conformity with an option of the respective vulnerability scanners.

In basic, the common scanning policies as defined above are mapped to the major scanning options of the respective vulnerability scanners. A portion of the common scanning policies may be directly mapped to the options of the respective vulnerability scanners, and a portion thereof is able to be emulated at an agent.

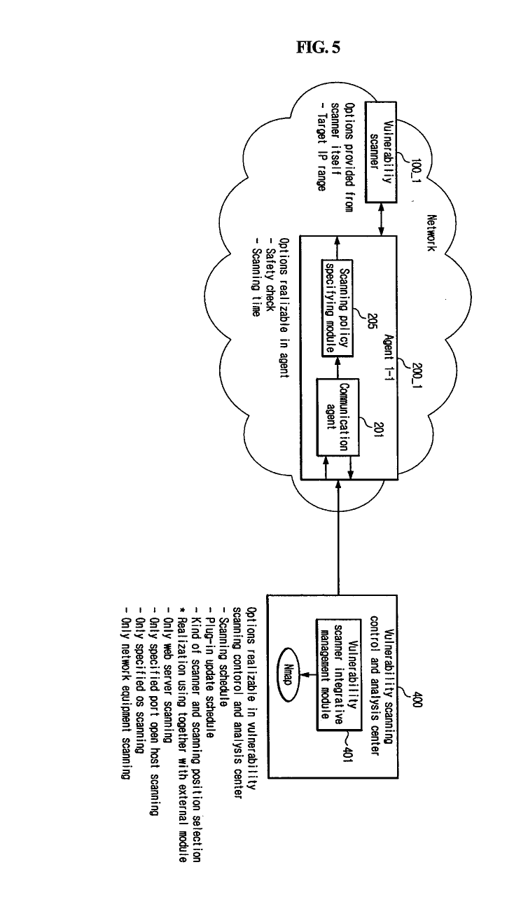

FIG. 5 is a constructional diagram in which a common scanning policy is specified in conformity with the options of the respective vulnerability scanners according to an embodiment of the present invention.

Referring to FIG. 5, ‘a target IP range’ and ‘a web server IP and a port’ among the common scanning policies are the common scanning options of all the scanners so they can be transferred to all the scanners as they are.

The options of ‘only web server scanning’, ‘only specified port open host scanning’, ‘only specified OS scanning’, and ‘only network equipment scanning’ identifies the scanning targets having indicated characteristics, utilizing an external tools such as nmap and the like. Then, only the identified scanning targets are transferred to the scanner as an input.

‘Scanning schedule’, ‘plug-in update schedule’, and ‘selection of the kind of scanners and scanning position’ can be specified in the scanner integrative managing module of the vulnerability scanning control and analysis center, and ‘safety check’ and ‘scanning time’ can be specified in an agent level.

The scanning options having no relevance to the common scanning policies and the scanning options existing only in a specified vulnerability scanner are selected in basic according to following principles.
An option that generates a great amount of traffics to have a large influence on a network available bandwidth is not selected.
An option able to make a system down is not selected.
An option able to generate service denial or service delay is not selected.
An option able to output a detailed and accurate result is selected as it can be.
All available options are selected so as not to miss any important vulnerability information.

The first three principles have priority over the last two principles. If there is a collision between the last two principles and the first three principles, the first three principles prevail.

D. Scanning Result Generalization Technology (S220 in FIG. 4)

When the vulnerability scanning is terminated, the agent collects the scanning results and transfers the same to the vulnerability managing and integrating module. However, since the formats and the described contents of the scanning results are different according to the vulnerability scanners, for relevance analysis, a step is first required to transform into a common format. Accordingly, the agent performs to transform the scanning results into a common format before transferring the scanning format.

The common format of the vulnerability scanning results is as follows. All vulnerability scanning results are essentially transformed into the following format. The fields of ‘scanner name’, ‘degree of severity’, and ‘vulnerability description’ are essential ones so that they should be filled with contents. Since the vulnerability title, the approved vulnerability ID, and the plug-in ID may not be provided according to the vulnerability scanners, they are not designated as an essential one.

| | | | | | |
|---|---|---|---|---|---|
| Vulnerability | Scanner | Approved | Plug-In | Degree of | Vulnerability |
| Title | Name* | Vulnerability | ID | severity* | Description* |
| | | ID | | | |

*denotes an essential field.

Definitions and contents description regulations for each field are as follows:

Vulnerability Title (Selective Item)
If a field of vulnerability title exists in the scanning results, the value of the field is used as it is.
If a field of vulnerability title does not exist, it is done to find out the approved vulnerability ID information such as CVE ID or Bugtrag ID and to use a common vulnerability title associated therewith.
If a single vulnerability is associated with one or more CVE IDs or Bugtraq ID, it is done to use a vulnerability title associated with a single ID according to the following priority.
CVE ID>Bugtraq ID>Cert advisory ID>Microsoft security bulletin ID
   The reason why the CVE ID is designated as high priority is because it is now most generally used and the verification is done through a vendor neutral forum and an editing committee.

Scanner Name (Essential Item)
The scanner name is indicated in full name.

Vulnerability ID (Selective Item)
If an approved vulnerability ID such as CVE ID, Bugtraq, and so forth is specified in a specified field, the field value is used as it is or through the parsing.
If the vulnerability ID field does not exist, it is done to detect whether approved vulnerability ID such as CVE ID, Bugtraq, and so forth is specified in a vulnerability description field and to use the value through the parsing.
If several approved IDs are associated, only one among them is selected according to the following priority.
CVE ID>Bugtraq ID>Cert advisory ID>Microsoft security bulletin ID

Plug-In ID (Selective Item)
If a plug-in ID field exists in the vulnerability scanning results, the field value is used as it is.

Degree of Severity (Essential Item)

A level of the degree of severity may be different according to the vulnerability scanners. It may be in general expressed in thee levels. However, it may be expressed in five levels, or may not be expressed. For consistent expression of the degree of severity, the scanning results of all vulnerability scanners are re-defined as three levels of high, middle, and low as follows:

| Severity | Description |
|---|---|
| High | Vulnerability that, upon abuse, serious problem may occur |
| | so a security manager should essentially check and remove |
| Middle | Vulnerability that, upon abuse, serious problem may not occur |
| | but a security manager needs to further check whether |
| | it is harmful. |
| Low | Which is not determined as vulnerability and corresponds to |
| | information in the level of being referred to in a network |
| | or system security management |

If the degree of severity of the vulnerability scanner does not have three levels above, it is transformed into the three levels according to the following regulations:
If there is no the degree of severity, all are transformed into middle.
If the degree of severity is expressed in two levels, the first level is transformed into middle, and the second level into high.
If the degree of severity is expressed in three levels, it is transformed as it is.
If the degree of severity is expressed in four levels, the first level and the second level are transformed into low, the third level into middle, and the fourth level into high.
If the degree of severity is expressed in five levels, the first level and the second level are transformed into low, the third level and the fourth level into middle, and the fifth level into high.

If the above transform regulations are not applied as they are, based on the long experiential insight on a specified vulnerability scanner, the transform regulations can be made different according to the definition of three levels of degree of severity. For instance, in case where in four levels transformation, if the vulnerability belonging to the second level is not just simple information but material information requiring a manager's check, both the second level and the third level may be transformed into middle.

Vulnerability Description (Essential Item)
If a description field exists in the vulnerability scanning results, it is used as it is.
If a description field does not exist separately in the vulnerability scanning results, all or part of contents of the vulnerability scanning results may be used while being combined.

E. Relevance Analysis Technology (S301 in FIG. 4)

A cross-checking method using multiple heterogeneous vulnerability scanners is able to enhance the comprehension and the accuracy of the scanning. Of importance in connection with the accuracy of the scanning results is the process of eliminating the duplication through the relevance analysis in order for an integrative analysis of the scanning results by the heterogeneous vulnerability scanners. The same vulnerabilities as detected by the multiple heterogeneous vulnerability scanners enhance the conviction of the existence of the vulnerability.

A method able to output the most accurate result through a relevance analysis between the scanning results by the heterogeneous vulnerability scanners is a manual mapping method through a plug-in analysis. However, this method is time-consumable so it cannot fast cope with newly emerging vulnerability. Moreover, it has problems in that much analysis time is taken on the whole plug-in whenever a new scanner is used, and that mapping information should be updated through an analysis whenever a plug-in is updated.

In an embodiment of the invention, the mapping is carried out based on only vulnerability scanning results without analyzing the plug-in of the respective scanners. Accordingly, there are no needs to analyze plug-in information of a vulnerability scanner and to update mapping information whenever scanning information for new vulnerability is added.

For an integrative analysis of the scanning results of the heterogeneous vulnerability scanners and a relevance between the now and the prior scanning results, it is needed an identification ID for each vulnerability. In an embodiment of the invention, a method is adapted so that an approved vulnerability identification ID is basically used, and No-match ID is newly issued to the vulnerability with no approved ID and a record thereof is managed.

Mapping using Approved Vulnerability Identification ID

Many vulnerability scanners provide the scanning results together with the approved vulnerability identification ID information. In this case, the vulnerability information is mapped according to the following priority.
CVE ID>Bugtraq ID>Cert advisory ID>Microsoft security bulletin ID

The approved vulnerability ID information may be provided to a specified field in the scanning results of the respective vulnerability scanners, and also included in a vulnerability description field. Such vulnerability ID information is stored in a field of ‘vulnerability ID’ when transformed into a common format. Accordingly, if information exists in ‘the vulnerability ID’ field, which means the existence of the approved vulnerability ID, the information is used in a vulnerability mapping process.

Offering Identifier to Vulnerability With No Approved Vulnerability ID

The cases of not providing approved vulnerability ID information are in general divided into two types. The first is where the vulnerability is recently detected one so an approved vulnerability ID is not yet provided, and the second is where the vulnerability is not important.

The case of being of high severity and having no approved vulnerability ID may be considered as the vulnerability that is recently detected and rapidly propagated. In this case, it is done to generate No-match ID and to record the characteristics of the vulnerability as follows such that the same No-match ID will be used for the same vulnerability to be detected in the future. If an approved vulnerability ID is issued for that vulnerability in the future time, mapping information between approved vulnerability ID and No-match ID is stored.

<No-match ID Table>

| | | | | | |
|---|---|---|---|---|---|
| No-match | Vulnerability | Scanner | Plug-In | Vulnerability | Approved |
| ID | Title | Name | ID | Description | Vulnerability |
| | | | | | ID |

The vulnerability having low severity (middle or low degree of severity) and no approved ID is of low importance as vulnerability information and does not have a large influence on the vulnerability integrative analysis, so that the vulnerability is not allocated with No-match ID and is regarded as individual vulnerability. In the vulnerability result integrative analysis, the analysis is performed on the vulnerability with high degree of severity.

F. Integrative Analysis Technology (S302 in FIG. 4)

Severity Integration

Upon analysis of vulnerability, it is important to detect all of vulnerabilities rather than a portion thereof Although vulnerabilities of 99% have been detected, it cannot make sure that the severity is reduced to that extent. If the administrative privilege of the major system is obtained with the vulnerability of only 1%, a worst-case scenario may be caused as is the same case where a network in which a severity analysis is not performed is hacked. Accordingly, it should not miss out even a single vulnerability with high severity upon vulnerability analysis.

In case of using the multiple heterogeneous vulnerability scanners, the severity evaluations on the same vulnerabilities may be different. In this case, when considering the inaccuracy of the scanning results and the fact that all vulnerabilities with high severity should be detected, it is preferable to use the highest severity as integrative severity of the vulnerability thereof.

Severity integrating regulations and a determination process are as follows:
In case where at least one vulnerability scanner evaluates the severity of vulnerability as ‘high’, the severity thereof is determined as ‘high’.
In case where at least one vulnerability scanner evaluates the severity of vulnerability as ‘middle’ and the other vulnerability scanners as ‘low’, the severity thereof is determined as ‘middle’.
In case where all of vulnerability scanners evaluate the severity of vulnerability as ‘low’, the severity thereof is determined as ‘low’.

Accuracy Analysis

If the specified vulnerability is detected by the multiple heterogeneous vulnerability scanners, it can be evaluated that a possibility that the vulnerability exists is relatively high. However, although the vulnerability is detected by some of the multiple heterogeneous vulnerability scanners used, it cannot be assumed that a possibility that the vulnerability exists is low. This is because the scaring domain and items may be different for each vulnerability scanner, and the scanning accuracy of some vulnerability scanner may be high.

All vulnerabilities the severities of which are evaluated as high irrespective of the number of the vulnerability scanners that detect the vulnerabilities should be targets to be analyzed and checked. This is in order not to miss out even a single possible vulnerability. In case of the vulnerability whose severity is evaluated as high, the security manager determines whether or not it is finally true through actual checking.

In an embodiment of the invention, there is provided a method for predicting the accuracy of the vulnerability detected through scanning results based on the reliability expected by the security manager in light of his experience with the vulnerability scanner.

The security manager can set up reliability to each vulnerability scanner in order to predict the accuracy of the vulnerability. The security manger may set up different reliability to each vulnerability scanners and the reliability is reflected to the accuracy of the vulnerability according to the following regulations.

The reliability of the vulnerability scanner means how much percentage is reliable from the vulnerabilities detected through the scanning results of the corresponding vulnerability scanner. This is calculated based on the manager's experiential reliability on the corresponding vulnerability scanner, and automatically regulated through the manager's feedback activity. The calculated reliability range is set to 1.0˜0.1 (unit of 0.1).

The accuracy on the vulnerability means a possibility that the vulnerability actually exists in a target system. The measuring of the accuracy on the vulnerability is determined by the summation of the reliability of the vulnerability scanners that detect the vulnerability.

For example, if there are a vulnerability scanner A with reliability of 0.8, a vulnerability scanner B with reliability of 0.4, and a vulnerability scanner C with reliability of 0.3, the vulnerability detected by the vulnerability scanner A has the accuracy of 0.8, and the vulnerability detected by both vulnerability scanners B and C has the accuracy of 0.7.

The reliabilities on the respective vulnerability scanners can be automatically regulated through a statistical analysis on the security manager's feedback activity.

Vulnerability Title Integration

In case where an approved vulnerability ID exists in the vulnerability information, the vulnerability titles on the same vulnerabilities detected by the heterogeneous vulnerability scanners are determined in one according to the following sequence, and the vulnerability title associated with the ID is used. That is, the approved vulnerability title designated by an agency managing the approved ID is used.
CVE ID>Bugtraq ID>Cert advisory ID>Microsoft security bulletin ID

In case of no approved vulnerability ID, a vulnerability title field of the scanner with high reliability is used as it is.

Vulnerability Description Integration

In case where an approved vulnerability ID exists in the vulnerability information, the vulnerability descriptions on the same vulnerabilities detected by the heterogeneous vulnerability scanners are determined in one according to the following sequence, and the vulnerability description associated with the ID is used. That is, the approved vulnerability description designated by an agency managing the approved ID is used.
CVE ID>Bugtraq ID>Cert advisory ID>Microsoft security bulletin ID

In case of no approved vulnerability ID, a vulnerability description field of the scanner with high reliability is used as it is.

Storage of Integrative Analysis Result

When a relevance analysis and an integrative analysis are terminated, the integrated scanning results are stored in a following table.

<Integrative Table>

| | | | | | |
|---|---|---|---|---|---|
| Vulnerability | Vulnerability | Scanner | Plug-In | Degree of | Vulnerability |
| ID* | Title | Name* | ID | severity* | Description* |

*denotes an essential field.

The scanning results can be shown through a graphical User Interface (GUI) in such a manner as to be easily understood about the scanning results the security manager should essentially perceive based on data stored in the integrative table.

G. Feedback Reflection Technology (S303 in FIG. 4)

A manager can correct an error on the integrative analysis results such as an error of automated integrative analysis process, a scanning result error of the respective scanners, and so forth. In case of the vulnerability to which an approved vulnerability ID is newly issued, the information on the vulnerability may be corrected and reflected to the integrative analysis results.

The following items are ones that a security manager can feed back in the process of checking the integrative analysis results.
In case where the same vulnerabilities are allocated with a plurality of No-match IDs, a manager can integrate and correct them to have a single No-match ID.
In case where the vulnerability with No-match ID has an approved vulnerability ID, No-match ID can be mapped to the approved vulnerability ID.
It is possible to correct and delete the vulnerability that is checked not to actually exist upon the checking.

The vulnerability that is checked not to exist in the process of checking the scanning results can be corrected by a manager, and the reliability of the corresponding vulnerability scanner is regulated to be down based on the statistical data for correction activity. A manager can randomly regulate the reliability of the vulnerability scanner.

As set forth before, according to the invention, it is possible to obtain complementary vulnerability scanning utilizing the multiple heterogeneous vulnerability scanners, to enhance the accuracy and the comprehension of the scanning results, and to obtain a comprehensive vulnerability analysis on a network.

Moreover, it is possible to flexibly select a vulnerability scanner in conformity with the network environments and the economical situations of a company because the multiple heterogeneous vulnerability scanners can be adapted without depending upon a specified vulnerability scanner.

Furthermore, an automated vulnerability scanning and integrative analysis process is effective in large scaled and complex network security management and which makes it possible to obtain fast security checking and countermeasure for the recent tendency in which upon finding out a new vulnerability, a hacking technology using the vulnerability is fast distributed and worm viruses using the vulnerability are fast diffused.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An integrative analysis system for network vulnerability, utilizing multiple heterogeneous vulnerability scanners, the system comprising:
multiple heterogeneous vulnerability scanners for scanning the vulnerability of a network;
a plurality of agents installed on the same system as those of respective vulnerability scanners to perform the execution and control for the corresponding vulnerability scanner, the reception of the scanning policy, and the transfer of the scanning results;
a vulnerability managing and integrating module collecting the scanning results of the respective vulnerability scanners while communicating with the respective agents, performing a relevance analysis of the scanning results, and storing a analysis result in a vulnerability database; and
a vulnerability scanning control and analysis center performing the control and the execution of the multiple heterogeneous vulnerability scanners, performing an integrative analysis based on the scanning results of the multiple heterogeneous vulnerability scanners and the relevance analysis result to show to the manager through a graphical user interface (GUI), providing the manager with a query for the integrative analysis result and a feedback function, and managing scanning policy history to maintain the consistency of the vulnerability scanning policy.

2. The system according to claim 1, wherein the respective agents comprises:
a communication agent module communicating with the vulnerability scanning control and analysis center and the vulnerability managing and integrating module;
a vulnerability scanner control module performing a command on vulnerability control transmitted from the vulnerability scanning control and analysis center, transferring a result of command execution, and performing a command including any of vulnerability scanning execution, pause, re-start, stop, state reference of the vulnerability scanner;
a scanning policy specifying module adapting a common scanning policy transmitted from the vulnerability scanning control and analysis center to the corresponding vulnerability scanner; and
a scanning result generalization module transforming the scanning results into a generalized format able to be received by the vulnerability managing and integrating module and transferring the same.

3. The system according to claim 1, wherein the vulnerability managing and integrating module comprises:
a vulnerability manager communicating with the respective agents and the vulnerability scanning control and analysis center and transferring an external request to a module in charge;
a scanning policy management module storing the scanning policy transferred from the vulnerability scanning control and analysis center and retrieving the scanning policy adapted in the past according to a request;
a scanning result integration module connected with the respective agents to collect the scanning result and store the same in the vulnerability database;
a vulnerability database manager being in charge of input/output with the vulnerability database; and
a relevance analysis module analyzing the scanning results collected from the multiple heterogeneous vulnerability scanners in terms of their relevance to identify the same vulnerabilities and to eliminate the duplication.

4. An integrative analysis method of network vulnerability utilizing multiple heterogeneous vulnerability scanners, the method comprising:
a scanning policy setting-up step of setting-up a common scanning policy able to be adapted to the multiple heterogeneous vulnerability scanners and specifying the policy for the respective vulnerability scanners;
a vulnerability scanning and result collecting step of performing for the multiple heterogeneous vulnerability scanners to scan, to collect a result thereof, and to store the same in a database; and
a scanning result integrative analysis step of performing a relevance analysis and an integrative analysis on the scanning results collected.

5. The method according to claim 4, wherein the scanning policy setting-up step comprises:
generating the common scanning policy;
adapting the common scanning policy to the multiple heterogeneous vulnerability scanners and controlling the same; and
specifying the common scanning policy in conformity with the multiple heterogeneous vulnerability scanners.

6. The method according to claim 4, wherein the vulnerability scanning and result collecting step comprises:
performing the vulnerability scanning at the same time;
generalizing the scanning result after scanning; and
automatically collecting the scanning result from the multiple heterogeneous vulnerability scanners and storing the same.

7. The method according to claim 4, wherein the scanning result integrative analysis step comprises:
analyzing relevance between vulnerabilities detected by the heterogeneous vulnerability scanners;
performing an integrative analysis on the scanning result and storing a result thereof; and
performing a manager's feedback on the analysis result.

8. The method according to claim 7, wherein if there is a correction in the scanning result after the manager's feedback, the step returns to the integrative analysis and result storing step so that the scanning result is corrected and stored.
